(19) United States
(12) Patent Application Publication
(10) Pub. No.: US 2024/0350232 A1
(43) Pub. Date: Oct. 24, 2024

(54) SELF-LIGATING BRACKET FOR ORTHODONTICS

(71) Applicant: Bernhard Förster GmbH, Pforzheim (DE)

(72) Inventor: Carsten Wagner, Bretten (DE)

(73) Assignee: Bernhard Förster GmbH, Pforzheim (DE)

(21) Appl. No.: 18/637,130

(22) Filed: Apr. 16, 2024

(30) Foreign Application Priority Data
Apr. 21, 2023 (DE) DE102023110194.3

(51) Int. Cl. A61C 7/28

(52) U.S. Cl. CPC A61C 7/287

(57) ABSTRACT

A self-ligating bracket includes a base, an occlusal wall, a gingival wall and a groove. The groove separates the occlusal and gingival wall and extends continuously in a direction from mesial to distal. A slit extends in a gingival to occlusal direction. A resilient clamp has a first and second clamp leg connected by an occlusally or gingivally arranged clamp bend. The first clamp leg is inserted in the slit and can be moved in the gingival-occlusal direction between a closed and open position of the clamp. The clamp has an access opening for engagement of a bracket opener. The access opening is delimited laterally by two arms running in a V-shape towards each other. A distance measured from mesial to distal between the two arms is at least as large as the arm width of each of the two arms measured from mesial to distal.

### CROSS-REFERENCE TO RELATED APPLICATIONS

This application claims priority to the German application number DE 10 2023 110 194.3 filed on Apr. 21, 2023, the entire content of which is fully incorporated herein with this reference

### DESCRIPTION

### Field of the Invention

The invention relates to a self-ligating bracket comprising a base, an occlusal wall, a gingival wall and a groove. The groove separates the occlusal wall and the gingival wall from each other and extends continuously in a direction from mesial to distal. A slit extends in a direction from gingival to occlusal. A resilient clamp comprises a first clamp leg and a second clamp leg, which are connected to each other by an occlusally or gingivally arranged clamp bend. The first clamp leg is inserted in the slit and can be moved therein in the gingival-occlusal direction between a closed position and an open position of the clamp. The clamp has an access opening in the area of the clamp bend for engagement of a bracket opener.

### Background of the Invention

Such a bracket is known, for example, from U.S. Pat. No. 5,906,486 A. This bracket is equipped with a resilient clamp having two clamp legs and a clamp bend connecting the two clamp legs. In the area of the clamp bend, the clamp has a constant width in mesial-distal direction and a circular access opening for engagement of a bracket opener. Due to the access opening, the cross-section of the clamp is weakened, which can be detrimental to the strength of the clamp. The spring force of the clamp can decrease over time. The clamp can also break in the area of its cross-section being weakened by the access opening. In both cases, the bracket no longer fulfils its function.

From DE 10 2019 134 575 A1, a non-generic bracket is known, which also comprises a resilient clamp with two clamp legs and a clamp bend connecting the two clamp legs. However, the access opening for engagement of a bracket opener is located in the second clamp leg, which is hardly burdened by bending stresses. It can happen that plaque builds up in depressions and recesses of the bracket over time. Moving the clamp into its open position can be obstructed by plaque deposits, particularly if they are deposited in a slit in which the first clamp leg is inserted. If, after some time, an arch wire running through the groove is to be replaced, it is very easy for the clamp to be unintentionally bent by the bracket opener engaging the second clamp leg if the first clamp leg is sluggish or blocked. Even such a bracket can no longer perform its function properly.

### SUMMARY OF THE INVENTION

An object of the present invention is to improve a bracket of the kind mentioned at the outset. This object is achieved by means of a bracket having the features specified in claim 1. Advantageous embodiments of the invention are the subject of the dependent claims.

The self-ligating bracket for orthodontics according to the invention comprises a base, an occlusal wall extending from the base, a gingival wall extending from the base and a groove, which separates the occlusal wall and the gingival wall from each other and extends continuously in a direction from mesial to distal. The side of the bracket facing away from the groove is called the fastening side, which is prepared to be adhesively bonded to a tooth. The bracket according to the invention can be bonded with its fastening side to a lingual or a vestibular surface of a tooth. In specialist language, the groove is also referred to as “slot”. It is used to hold an arch wire. The arch wire usually passes through a sequence of brackets attached to a series of adjacent teeth. By pulling and/or twisting, a pretension can be created in the wire, which is transferred from the arch wire to the brackets and from them to one or a plurality of teeth in order to change their position.

The bracket has a slit that extends in a gingival-occlusal direction. The slit can be delimited by a lingual guiding surface and by a labial guiding surface. The bracket further comprises a resilient clamp, which has a first clamp leg and a second clamp leg, which are connected to each other by a curved section. This curved section is roughly C-shaped and shall hereinafter be referred to as the clamp bend. The clamp bend can be arranged occlusally or gingivally, depending on the orientation in which the bracket is bonded to the surface of the tooth. In the case of a bracket whose fastening side is intended to be bonded to a vestibular surface of a tooth, the first clamp leg is also called the lingual leg and the second clamp leg is also called the labial leg. The first clamp leg has a longitudinal direction in the gingival-occlusal direction and extends in a plane. The first clamp leg is inserted into the slit and can be moved in the gingival-occlusal direction between a closed position and an open position of the clamp. The longitudinal direction of the first clamp leg coincides with the displacement direction. The first clamp leg can be guided between the lingual surface of the slit and the labial surface of the slit. In an embodiment, the clamp is moved from gingival to occlusal for opening, the clamp bend is occlusally arranged. In such case, the second clamp leg extends into a cut-out in the gingival wall in the closed position of the clamp. In the open position of the clamp, the tip of the second clamp leg rests on the occlusal wall so that an arch wire can be inserted into the groove or removed from the groove. In the closed position, the second clamp leg closes the groove and rests springily against the arch wire in order to press it against the base of the groove. Such a bracket is therefore referred to as an “active bracket”. In the event that the arch wire exerts a force on the second clamp leg that exceeds the restoring force of the clamp, the cut-out in the gingival wall can be limited by a stop against which the second clamp leg comes into contact if the arch wire acts with a sufficiently large force on the second clamp leg. The stop thus limits the distance of the second clamp leg from the base of the groove. The stop in the gingival wall of the bracket also limits the largest possible dimension of the arch wire in the lingual-labial direction Alternatively, it can also be provided that the clamp is moved from occlusal to gingival for opening. In such a case, the clamp bend is gingivally arranged and the second clamp leg, in its closed position, extends into a cut-out of the occlusal wall, while in its open position, its tip rests on the gingival wall.

In the case of occlusally arranged clamp bend, the clamp can be held in its closed position by the fact that the second clamp leg springs against the occlusal wall when pushed forward into the closed position and can only be transferred from the closed position to the open position by elastic bending. In the case of gingivally arranged clamp bend, the second clamp leg springs against the gingival wall.

The clamp of the bracket according to the invention comprises an access opening in the area of the clamp bend for engagement of a bracket opener. The bracket opener is a tool for opening the clamp. The bracket opener can have a handle and an access end, particularly a cylindrical access end, for engaging in the access opening of the clamp. As a bracket opener, a probe can also be used, which a dentist usually uses to examine tooth surfaces. Accordingly, the access opening can also be referred to as a probe access opening. The access end of the bracket opener can be inserted into the access opening to move the clamp from its closed position to its open position. The first clamp leg can be set up in such a way as to prevent unintentional loss of the clamp. Due to interaction of the first clamp leg with other parts of the bracket, the clamp cannot be moved beyond its open position in the direction of the clamp bend to the occlusal side or gingival side, respectively. Corresponding embodiments of the first clamp leg are known, for example, from the documents U.S. Pat. No. 5,906,486 A and DE 10 2019 134 575 A1 mentioned at the outset. Pushing the first clamp leg out of the slit is limited so that the clamp cannot fall out of the slit.

According to the invention, it is provided that the access opening—in a view along the longitudinal direction of the first clamp leg or in a top view of the clamp unwound into a plane—is delimited laterally by two arms running in a V-shape towards each other. One of the two arms thus borders the access opening on its mesial side. The other of the two arms borders the access opening on its distal side. A distance between the two arms, measured in mesial-distal direction, is at least as large as the arm width of each of the two arms, measured in mesial-distal direction. The arm width of each of the two arms can be half the width of the clamp bend in the area outside the access opening. Each arm can have a segment running linear. Each of the two arms can be at most as wide as the largest distance between the two arms. The distance between the two arms can be at least 0.7 mm. The given dimension specifications and dimension ratios refer to the respective nominal dimension, which can vary within the scope of usual manufacturing tolerances.

The cross-section of the clamp in the area of the clamp bend significantly determines the spring characteristics of the clamp. The cross-section of the clamp in the area of the clamp bend has a maximum, which is hereinafter referred to as “the maximum cross-section”. The cross-section of the clamp in the area of the clamp bend also has a minimum, which is hereinafter referred to as “the minimum cross-section”. Each of the arms has an arm cross-section in the area of the access opening. The cross-section is the area of the cut surface of the clamp, which is cut along the longitudinal direction of the groove at the respective position. In case of a rectangular clamp cross-section, the cross-section can be calculated by multiplication of thickness and width of the clamp. The sum of the cross-sections of the two arms, measured at one point of the clamp bend, is not more than 10%, and particularly not more than 6%, smaller than the minimum cross-section.

The invention may have (but which are not necessary) significant advantages:

Due to the two arms running in a V-shape towards each other, an oblong access opening is created, which, due to its large width near the second clamp leg, allows easy insertion of the bracket opener.

Simultaneously, the two arms running in a V-shape towards each other have a centering effect on the bracket opener. As a result, the bracket opener is centered during the opening process in the mesial-distal direction and sits in the middle of the clamp.

The oblong access opening allows the access opening to be brought closer to the first clamp leg. The access opening can therefore be positioned in the clamp bend very close to the base of the bracket. As a result, the opening force exerted by the bracket opener can act approximately in the middle between the two clamp legs.

The central force application optimizes the forces applied onto the clamp by the bracket opener. At the beginning of the opening process, the opening force is evenly distributed over both clamp legs so that even a clamp that is sluggish due to dirt can be opened without distortion.

Due to the centering effect of the two arms, the point of force application of the bracket opener can shift even closer to the first clamp leg in the course of the opening process. As a result, a greater proportion of the opening force acts on the first clamp leg than on the second clamp leg. This further simplifies the opening of the clamp, as the first clamp leg is often sluggish over the entire shifting path due to plaque deposits, while, with respect to the second clamp leg, after overcoming an initial blockage, there is no appreciable sluggishness in the further course of the opening movement.

The invention can ensure that-apart from manufacturing tolerances—the sum of the arm sections matches the cross-section of the clamp in the area of the clamp bend outside the access opening. This applies even if the width of each of the two arms is half as wide as the smallest width of the clamp bend outside the access opening.

It can be prevented that the clamp is weakened by the access opening in the area of the clamp bend, which is the area of the clamp most stressed by bending stresses. Due to the two arms running in V-shape towards each other, the width of the clamp can be increased in the area of the clamp bend without changing the cross-section of the clamp. The cross-section of the clamp, which determines the spring effect, can be kept practically constant over the entire clamp bend. As a result, a uniform bending behavior can be achieved over the entire clamp bend. The bending behavior and spring characteristics of the clamp improve.

The clamp according to the invention has a very high stability and fatigue strength as well as a good cycle resistance. This means that taking into account 240,000 chewing cycles per year in a patient's mouth, the spring force does not decrease appreciably even during a period of use of 18 months or more. In addition, clamp breakage due to material fatigue can be avoided.

The clamp can be made very easily from a sheet metal. The oblong access opening can be made very easily before bending, for example, by being punched out. Apart from the clamp bend in the area between the two clamp legs, no plastic deformation of the clamp is required during its production.

In a further embodiment of the clamp, the angle between the two arms can be in the range of 40° to 75°, particularly in the range of 45° to 70°. One of the arms—in a top view of the clamp unwound into a plane—can run at an angle to the longitudinal direction of the clamp in the range of 20° to 45°, particularly in the range of 23° to 33°. The mentioned angle of the arm can be particularly measured in relation to the longitudinal direction of the first clamp leg. A possible angulation of the bracket can have to be taken into account in addition to the mentioned angular ranges.

In an embodiment, the oblong access opening can extend over at least 50%, particularly at least 55%, of the clamp bend. The oblong access opening can extend over a bending angle of the clamp bend of at least 100°, particularly at least 120°. In particular, with a total bending angle of 200° or more, the access opening can extend over a bending angle of at least 125°. The term “total bending angle” refers to the total bending angle of the clamp bend from the first clamp leg to the second clamp leg. The segment of the clamp bend with the two arms running in a V-shape to each other can be adjoined by a segment of the clamp bend in which the two arms run parallel to each other. The segment, in which the two arms run parallel to each other, can adjoin the second clamp leg. Each arm can extend with an essentially constant arm width over a segment of the clamp bend. As a result, the oblong access opening can be enlarged so that it extends over a particularly large bending angle of the clamp bend.

In a further embodiment, the maximum cross-section can be not more than 20% larger than the minimum cross-section. The arm cross-sections of the two arms can differ by no more than 10% at one point of the clamp bend. In addition, a change in the cross-section of the arm along the course of the arm can be no more than 10% for each of the arms. Based on a clamp having a constant thickness, for example, this can be ensured, if the nominal width of each of the two arms has a tolerance of no more than +5%. In particular, segments of the clamp bend whose cross-sections are more than 10% larger than the minimum cross-section can only extend over not more than 20% of the total bending angle of the clamp bend, particularly over a bending angle not exceeding 30°. By taking these measures individually, particularly in combination with each other, cross-sectional changes due to manufacturing tolerances can be covered. The cross-section in the area of the clamp bend can be kept constant within narrow limits so that a particularly uniform bending behavior can be achieved over the entire clamp bend. Nevertheless, the total width of the clamp can increase in the area of the clamp bend by 50% or more, particularly by 50% to 70%, compared to the width of the first clamp leg. In addition, transition radii can be provided between different clamp segments to avoid sharp-edged transitions, for example from the segments containing the arms running in V-shape to a segments without access opening. In the case of a series of self-ligating brackets for orthodontics, which comprises a number of brackets according to the invention, it can be provided that the nominal dimension for the minimum cross-section of the clamp in the area of the clamp bend is the same for all brackets of the series. The minimum cross-section of one of the brackets in the series can differ by no more than 10% from the respective minimum cross-section of each of the other brackets of the series. This means that a particularly uniform bending behavior can also be achieved throughout the series of brackets, from which the brackets to be bonded to the patient's dental arch are selected. This allows uniform conditions to be achieved along the entire arch wire.

The clamp bend can have a center as viewed in a longitudinal section through the first clamp leg. If the clamp is bent with a uniform bending radius in the area of the clamp bend, this center is the center point of the bending radius, and the bend angle is the corresponding center angle. If the bending radius is not uniform, the bending angle can be measured analogously around an approximate center of the clamp bend. The center of the clamp bend—as viewed in a longitudinal section through the first clamp leg—can be at a first height H1 above the first clamp leg. The end of the access opening facing the first clamp leg can be located at a second height H2 above the first clamp leg. The second height H2 can be in a range delimited by the first height reduced by 20% and the first height increased by 20%. Thus, the second height H2 can be in a range of 0.8*H1 to 1.2*H1. In particular, the second height H2 can be in a range of the first height H1 plus/minus 0.1 mm (H1±0.1 mm). As a result, a central force application of the bracket opener can be ensured in a particularly good way so that the opening force is distributed particularly evenly over both legs at the beginning of the opening process.

In a further embodiment, the bracket can have a widened base on its fastening side, the width of which is greater than the corresponding width of the base measured from mesial to distal and/or from gingival to occlusal. Such a widened base is also known as a “pad” and can increase the area available for bonding the bracket on the fastening side, thereby improving the adhesion of the bracket to the tooth. The fastening side can also be provided with structures, such as undercut projections with an alternating orientation for example, which lead to a significantly better adhesion of the bracket to the tooth when the bracket is bonded to a tooth. In the case of brackets made of metal, the pad can also be manufactured separately and only subsequently connected to the base of the bracket by welding. The occlusal wall can have at least one occlusal ligature wing. The gingival wall can have at least one gingival ligature wing. Ligature wires can be attached to ligature wings in a way known per se. The wall assigned to the clamp bend can—as viewed along the longitudinal direction of the first clamp leg-comprise a recess at its end facing away from the base of the groove. Said recess can receive the second clamp leg and/or the clamp bend of the clamp located in its closed position. When the clamp is open, the second clamp leg can sit in the recess. This can improve the guidance of the clamp when opening and closing the clamp. In addition, the wearing comfort of the bracket for the patient can be improved. The depth of the recess can be at least 80% of the thickness of the clamp.

The slit in which the first clamp leg is inserted can run transversely to the groove, particularly perpendicular to the groove. In particular, the slit can extend continuously through the base, for example in form of a passage. Alternatively, the slit can be closed on the side of the bracket facing away from the clamp bend, wherein this can particularly be the gingival side of the bracket. The slit can run in the base between the groove and the fastening side of the bracket. In particular, the base of the groove can extend continuously from mesial to distal without interruption. As a result, there is no passage between the slit and the groove. This can simplify the production of the bracket, particularly of a single-piece bracket. In addition, there are less free spaces inside the bracket, which can become clogged by deposits.

In a further embodiment, the bracket can have a support surface for the bracket opener. The support surface faces the clamp bend. The support surface runs inclined to the first clamp leg. The support surface can run at an angle of 60° to 85°, particularly at an angle of 70° to 80°, to the first clamp leg. The slanted support surface can make it easier to open the clamp with the bracket opener. The groove of the bracket can have sloping surfaces and/or curvatures at its distal end and at its mesial end. In the groove, two ribs can be provided on the wall facing the clamp bend, in particular on the occlusal wall, which ribs extend in the lingual-labial direction. The ribs can have chamfered or rounded edges. Due to the ribs, it is very easy to fine-tune the width of the groove measured in the gingival-occlusal direction when manufacturing the bracket. The bracket can have a rounded edge.

### BRIEF DESCRIPTION OF THE DRAWINGS

Further details and advantages of the invention are explained using exemplary embodiments of the invention with reference to the attached drawings. Identical and corresponding components are provided with correlative reference numbers. The figures show:

FIG. 1 a perspective and greatly enlarged illustration of a first exemplary embodiment of a bracket according to the invention with a clamp in the closed position;

FIG. 2 the bracket of FIG. 1 in a corresponding view, wherein the clamp is in the open position;

FIG. 3 a top view of the bracket of FIG. 1;

FIG. 4 a view of the bracket cut along the cut surface IV-IV in FIG. 3;

FIG. 5 a view of the bracket cut along the cut surface V-V in FIG. 3;

FIG. 6 a top view of the clamp of the bracket of FIG. 3;

FIG. 7 a view of the clamp in the direction of arrow VII in FIG. 6;

FIG. 8 a view of the clamp cut along the cut surface VIII-VIII in FIG. 7;

FIG. 9 a top view of the clamp of FIGS. 6 to 8 unwound into a plane;

FIG. 10 the bracket of FIG. 1 in a corresponding view together with a bracket opener;

FIG. 11 the bracket of FIG. 2 in a corresponding view together with the bracket opener;

FIG. 12 four sectional views a) to d) of the bracket of FIG. 4, which show intermediate steps in moving the clamp from its closed position to its open position with the bracket opener;

FIG. 13 a top view similar to FIG. 3 of a second exemplary embodiment of the bracket according to the invention;

FIG. 14 a top view of the clamp of the bracket of FIG. 13;

FIG. 15 a view similar to FIG. 7 of the clamp of FIG. 14; and

FIG. 16 a view similar to FIG. 9 of the clamp of FIG. 14.

### DETAILED DESCRIPTION OF EMBODIMENTS OF THE INVENTION

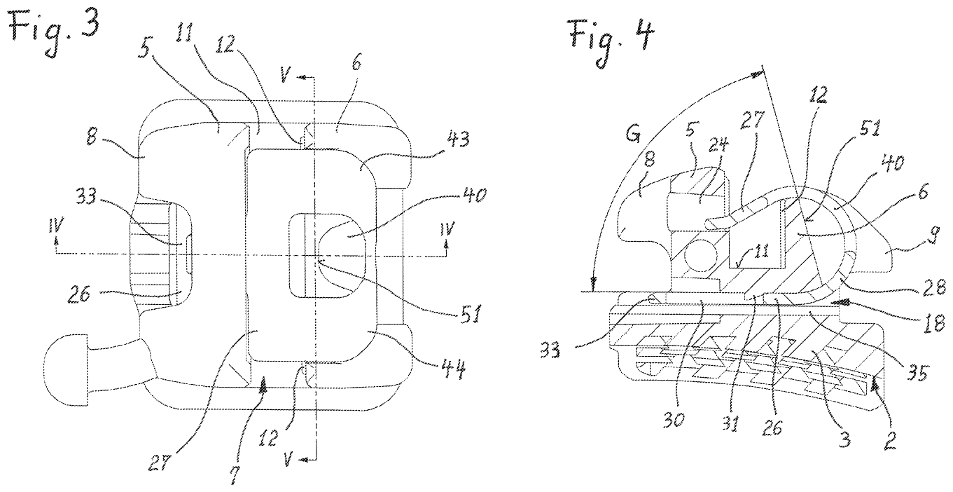

FIGS. 1 to 5 show an exemplary embodiment of a bracket 1 according to the invention. The bracket 1 according to the invention comprises a curved fastening side 2, the curvature of which is approximated to the vestibular side of a tooth (not shown). On the fastening side 2, projections 3 are arranged in rows. On the fastening side 2, an adhesive can be applied to bond the bracket 1 to the vestibular side of a tooth. The fastening side 2 thus forms the lingual side of bracket 1. In the case of a bracket to be bonded to the lingual side of a tooth, the indications “lingual” and “labial” must be exchanged accordingly. Bracket 1 comprises a base 4 from which a gingival wall 5 and an occlusal wall 6 extend. The two walls 5 and 6 run parallel to each other and are separated by a groove 7, which runs along a straight line from distal to mesial and is open towards the labial direction. Two ligature wings 8 protruding in the gingival direction are provided on the gingival wall 5. Two ligature wings 9 protruding in occlusal direction are provided on the occlusal wall 6. Thus, in FIG. 4, the orientation intended for the bracket on a tooth is as follows with regard to the directions: bottom lingual, top labial, right occlusal, left gingival and distal-mesial perpendicular to the drawing plane.

The groove 7 is used to accommodate an arch wire (not shown), which has a rectangular cross-section and is not part of the bracket. By prestressing the arch wire, torque can be applied to the base 11 of the groove 7 and to walls 5 and 6. For this purpose, the clear cross-section of the groove 7 is essentially rectangular. In the present case, it is delimited by the base 11 of the groove 7 and by two ribs 12 on the occlusal wall 6, which serve to reduce friction of the arch wire in the groove 7. The base 11 extends continuously from mesial to distal without interruption. At the ends of the groove 7 are provided rounded sloping surfaces 14 at the base 11, rounded sloping surfaces 15 at the gingival wall 5 and rounded sloping surfaces at the occlusal wall 6, which widen the entry of the groove 7 and also serve to reduce friction for the arch wire lying in the groove 7. This can be particularly favorable in the case of large misalignments of the teeth, which require a particularly irregular course of the arch wire.

Below the base 11 of the groove 7, a slit 18 runs parallel to the base 11, which is delimited by a lingual surface 19 and a labial surface 20 as well as by two narrow side walls 21. The side walls 21 are parallel to each other and extend between the lingual surface 19 and the labial surface 20. The slit 18 extends continuously through base 4 and is not connected to the groove 7.

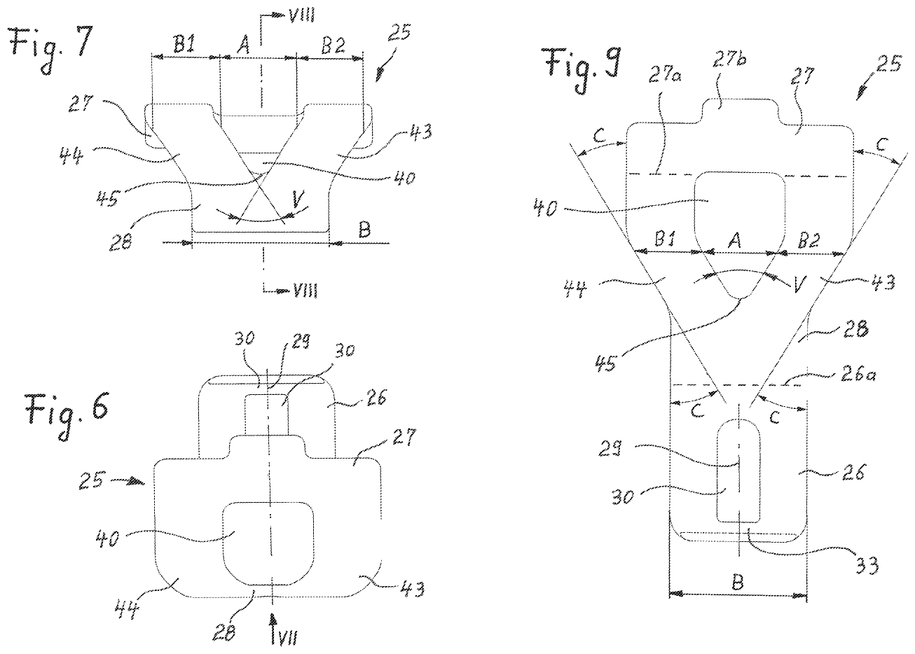

The bracket 1 in FIGS. 1 to 5 includes a clamp 25 made of a spring material, which is shown separately in FIGS. 6 to 9. This is cut out of a flat sheet metal of constant thickness D in the shape shown in FIG. 9 and then bent. It has a straight first clamp leg 26 and a shorter second clamp leg 27, which runs almost in a straight line. The first clamp leg 26 is the lingual leg and the second clamp leg 27 is the labial leg. The two clamp legs 26, 27 are connected by an approximately circular-arc-shaped section, which is referred to as the clamp bend 28. In the case shown, the clamp bend 28 forms an occlusally located segment of the clamp 25. In the case of a bracket to be bonded to a tooth in the opposite direction, the clamp bend 28 can form a gingival segment of the clamp 25 and the indications “occlusal” and “gingival” should be exchanged accordingly. The first clamp leg 26 fits into slit 18 with little play. The second clamp leg 27 has a width measured from mesial to distal, which approximately corresponds to the length of the groove 7 in the bracket. It does not run parallel, but at an acute angle to the first clamp leg 26, which it approaches coming from the clamp bend 28. The clamp bend 28 has a total bending angle F of 210°. The transition from the clamp bend 28 to the clamp legs 26, 27 is indicated in FIG. 9 by dashed lines, wherein the line 26a marking the beginning of the first clamp leg 26 and line 27a marking the beginning of the second clamp leg 27.

At its free (gingival) end, the second clamp leg 27 has an extension 27b extending towards the gingival and angled towards the labial direction. The extension 27b is narrower than the second clamp leg 27 and narrower than the first clamp leg 26; it fits with little play into a cut-out 24, which is arranged in the gingival wall 5.

The first clamp leg 26 comprises a longitudinal direction 29 and an oblong recess 30, which runs parallel to the longitudinal direction 29. The longitudinal direction 29 is indicated by a dotdashed line, cf. FIGS. 6 and 9. The recess 30 is designed as an oblong hole and is centrally located in the first clamp leg 26. A projection 31 protrudes lingually from the labial surface 20 of the slit 18 into the recess 30. The labial surface 20 is designed as a flat guiding surface for the first clamp leg 26. The projection 31 has the shape of a latching lug. The (occlusal) side of the projection 31 facing to the clamp bend 28 extends at an angle of about 20° to the guiding surface 20. The (gingival) side of the projection 31 facing away from the clamp bend 28 is more inclined to the guiding surface 20 than the side facing to the clamp bend 28. The projection 31 is formed in one piece at base 4. The recess 30 is delimited at its (gingival) end facing away from the clamp bend 28 by a stop 33, which is formed by a bar running from mesial to distal at the free (gingival) end of the first clamp leg 26. The lingual surface 19 of the slit 18 comprises two planar guiding surfaces 19a and 19b for the first clamp leg 26, between which a channel 35 is arranged. The guiding surfaces 19a, 19b run parallel to the guiding surface 20. Guiding surfaces 19a, 19b and channel 35 extend from gingival to occlusal over the entire length of the slit 18. When the clamp 25 is mounted, the first clamp leg 26 is inserted into slit 18 along the longitudinal direction 29. The stop 33 reaches the projection 31, and the first clamp leg 26 is resiliently deformed in lingual direction. The channel 35 forms an escape space into which the stop 33 can swerve if it slides over the projection 31 when the clamp 25 is inserted. The first clamp leg 26 is bent around its longitudinal direction 29 by the guiding surfaces 19a, 19b and the projection 31 in the area of stop 33. When the stop 33 is pushed over the projection 31, the first clamp leg 26 springs back into its planar initial shape. If the first clamp leg 26 is fully inserted into the slit 18, the clamp 25 is in its closed position, cf. FIGS. 1, 3 and 4.

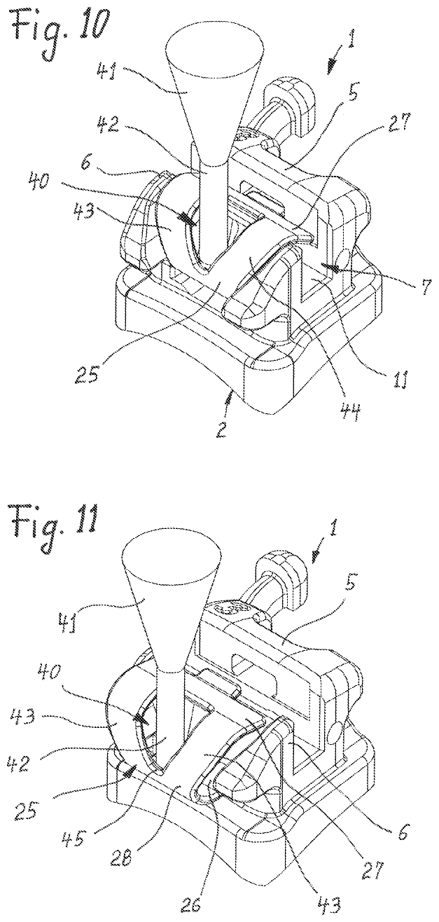

In order to move clamp 25 from the closed position to the open position, an access opening 40 is arranged in the area of the clamp bend 20, which can be accessed with a tool referred to as bracket opener 41, cf. FIGS. 10 to 12. The bracket opener 41 comprises a cylindrical access end 42 for engaging with the access opening 40. At its end, which is facing away from the access end 42, the bracket opener 41 has a handle (not shown). The access opening 40 is bordered laterally by a mesial arm 43 and a distal arm 44. In a view along the longitudinal direction 29 of the first clamp leg, see FIG. 7, and in a top view of the clamp 25 unwound into a plane, see FIG. 9, the two arms 43 and 44 run in a V-shape towards each other. The two arms 43, 44 have an angle V and a distance A to each other. The distance A is measured from mesial to distal. The angle V is about 63° in the shown embodiment. In the top view of FIG. 9, the two arms 43 and 44 each run at an angle C to the longitudinal direction 29 of the clamp 25, which is half as large as the angle V. The first clamp leg 26 has a constant width B, which is 1.44 mm in the shown embodiment. The smallest width of the clamp bend 28 in the area outside the access opening 40 coincides with the width B. Arm 43 has a constant width B1, which is half the width B. Arm 44 has a constant width B2, which corresponds to the width B1. To prevent the two arms 43 and 44 from running pointy towards each other in the V-shaped area, a transition radius 45 is provided. Starting from the transition radius 45, the distance A increases with increasing distance from the first clamp leg 26. The segment in which the two arms 43 and 44 run V-shaped to each other is followed by a segment of the clamp bend 28, in which the two arms 43, 44 run parallel to each other and have a constant distance A. At least at one point of the clamp bend 28, a distance A can be measured between the two arms 43, 44, which is at least as large as the width B1 and as the width B2. In the shown embodiment, the distance A in the area of the access opening 40 facing away from the transition radius 45 is even 0.96 mm. The oblong access opening 40 extends over a bending angle E of the clamp bend 28 of 126°, and thus more than 60% of the total clamp bend 28 with its total bending angle F of 210°.

The clamp bend 28 is bent with a bending radius of 0.55 mm. In the longitudinal section of the first clamp leg 26 shown in FIG. 8, the center 46 of the clamp bend 28 is thus at a height H1 of 0.55 mm above the first clamp leg 26. The end of the access opening 40 facing the first clamp leg 26, i.e., the lower end in FIGS. 7 and 8, which is delimited by the transition radius 45, lies at a second height H2 above the first clamp leg 26. The second height H2 is in a range delimited by the first height (0.9*H1) reduced by 10% and the first height (1.1*H1) increased by 10%. This calculation rule (H1±10%) therefore results in a range for the second height H2 from 0.495 mm to 0.605 mm.

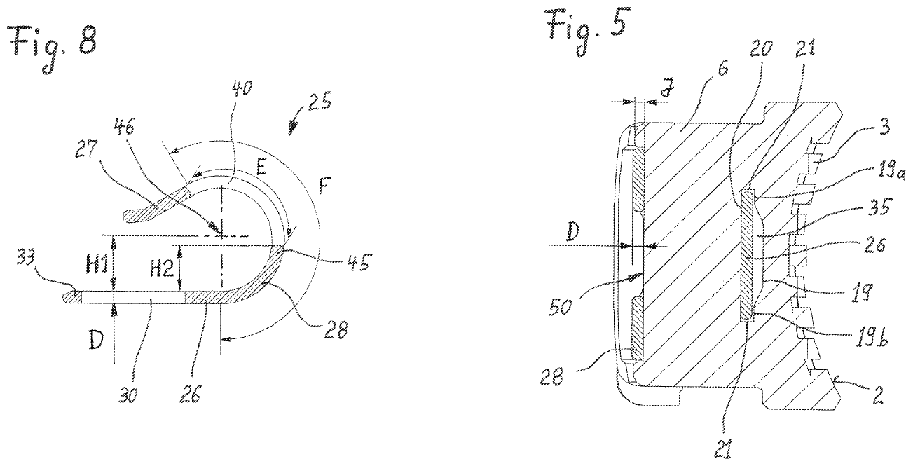

In FIG. 5, the cut surfaces of the intersected clamp 25 can be seen, which cut surfaces show the respective cross-section of the clamp 25. In the shown embodiment, the sum of the arm cross-sections of both arms 43, 44 coincides with the cross-section of the first clamp leg 26. Due to the constant thickness D of the clamp 25, the minimum cross-section in the area of the clamp bend 28 outside the access opening 40 is located in the area of the smallest width B, cf. FIG. 9. In the direction of the transition radius 45, the cross-section increases due to the increasing width of the clamp 25. The maximum cross-section of the clamp bend 28 is located in the area of the transition radius 45. In the shown embodiment, the width there is 1.64 mm so that the maximum cross-section is 14% larger than the minimum cross-section. In the area of the parallel arms 43, 44, the outer clamp width is 2.4 mm, which is 67% larger than the smallest width B of 1.44 mm. However, due to the above-mentioned nominal dimensions B1 and B2, the sum of the two arm cross-sections corresponds to the minimum cross-section outside the access opening 40. As a result, the clamp 25 has very good bending behavior and uniform spring characteristics, resulting in a high fatigue strength of the clamp 25.

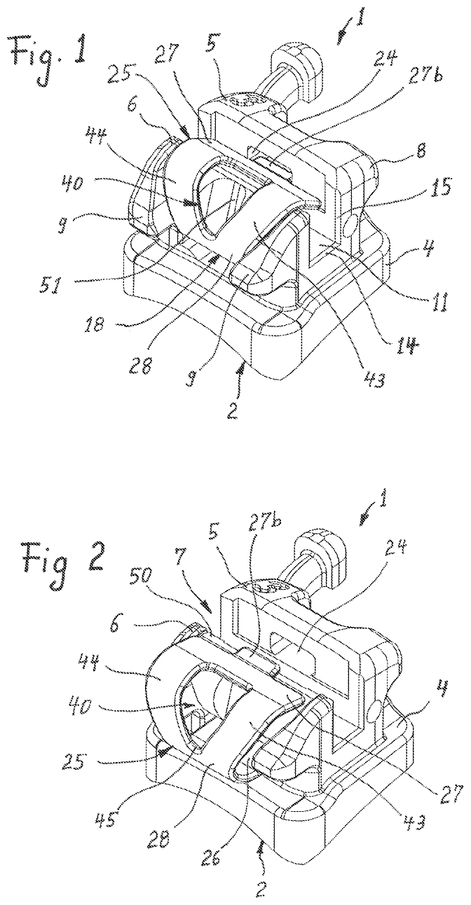

The (occlusal) wall 6 assigned to the clamp bend 28 has a recess 50 at its (labial) end, which is facing away from the base 11 of the groove 7. The clamp bend 28 of the clamp 25 in its closed position is located in said recess 50, cf. FIG. 5. The depth J of the recess 50 is at least 80% of the thickness D of the clamp 25. When the bracket is open, the second clamp leg 27 sits in the recess 50, cf. FIG. 2. The bracket 1 comprises a support surface 51 for the access end 42 of the bracket opener 41. The support surface 51 faces the clamp bend 28. The support surface 51 runs inclined to the first clamp leg 26 at an angle G=75°.

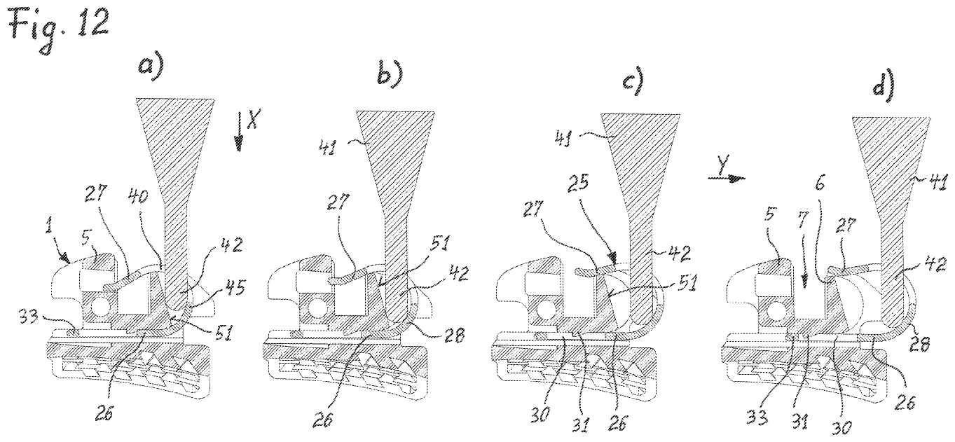

In order to move the clamp 25 from its closed position, cf. FIG. 1, to its open position, cf. FIG. 2, the bracket opener 41 is inserted into the access opening 40 with its access end 42, cf. FIG. 10 and FIG. 12 a). The access end 42 is positioned in the middle of the area of the clamp bend 28 by the support surface 51 and the two arms 43 and 44 running in a V-shape towards each other when it is inserted in the direction of the arrow X of FIG. 12. The access end 42 then rests in the area of the transition radius 45 on the clamp 25, cf. FIG. 12 a), while the clamp is still in its closed position. If the access end 42 is pressed further in the (lingual) direction X, the opening force exerted by the access end 42 is initially distributed essentially equally between the two clamp legs 26 and 27. The opening movement of the clamp 25 begins and the access end 42 slides along the support surface 51. The access end 42 approaches the first clamp leg 26, cf. FIG. 12 b). If the access end 42 is then pressed further in the direction of the arrow Y of FIG. 12, a larger part of the opening force exerted by the access end 42 acts on the first clamp leg 26, cf. FIG. 12 c). This is particularly advantageous if there are plaque deposits in slit 18 and the first clamp leg 26 is sluggish. The projection 31 is accommodated in the recess 30 and does not interfere with the movement. The displacement movement in the (occlusal) direction Y ends when the stop 33 hits the projection 31, cf. FIG. 12 d). Clamp 25 is then in its open position, cf. also FIG. 11. In this opening position, the second clamp leg 27 has a resting position on the occlusal wall 6, in which it provides access to the groove 7 from the labial direction.

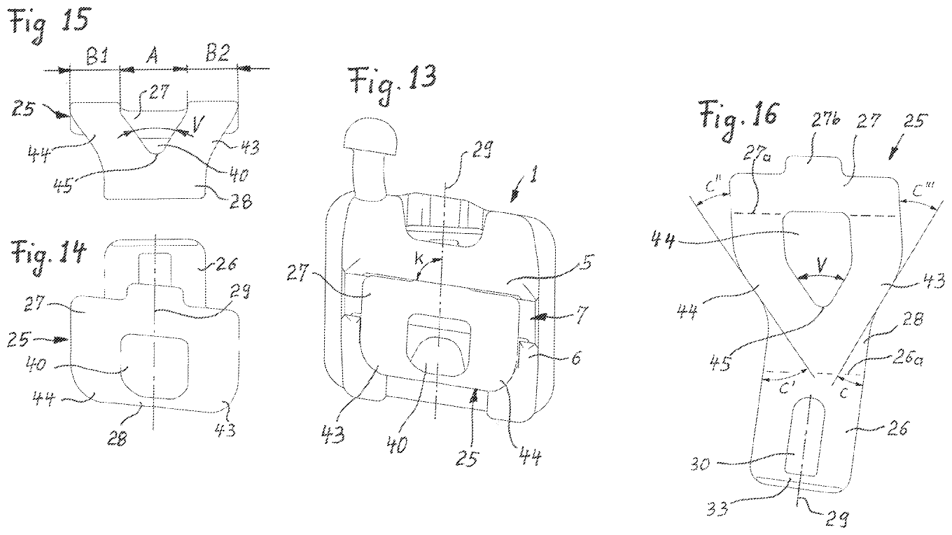

The first exemplary embodiment of bracket 1 in accordance with FIGS. 1 to 11 is a non-angulated bracket in which the slit 18 is perpendicular to the groove 7. Accordingly, the clamp 25 runs in along straight line, cf. FIG. 9. The second exemplary embodiment shown in FIGS. 13 to 16 is a bracket 1 angulated by 6°. The angle K between the groove 7 and the slit 18 or the longitudinal direction 29 of the first clamp leg 26 is thus 84°. This results in different angles C, C′, C″ and C′″ of the two V-shaped arms 43 and 44 to the longitudinal direction of the clamp 25. The constant width B1 and B2 of arms 43 and 44 results in V=C+C′ and V=C″+C′″, respectively. In addition, the design and functioning of the second exemplary embodiment is the same as that of the first exemplary embodiment so that reference is made to it in order to avoid repetition.

### LIST OF REFERENCE NUMERALS

1 bracket
2 fastening side
3 projections
4 base
5 gingival wall
6 occlusal wall
7 groove
8 gingival ligature wings
9 occlusal ligature wings
11 base of the groove 7
12 ribs on wall 6
14 sloping surfaces at the base 11
15 sloping surfaces on wall 5
18 slit
19 lingual surface
19a guiding surface
19b guiding surface
20 labial surface
21 side walls
24 cut-out
25 clamp
26 first clamp leg
26a beginning of the first clamp leg
27 second clamp leg
27a beginning of the second clamp leg
27b extension
28 clamp bend
29 longitudinal direction
30 recess
31 projection
33 stop
35 channel
40 access opening
41 bracket opener
42 access end
43 mesial arm
44 distal arm
45 transition radius
46 center
50 recess
51 support surface
A distance
B width
B1 arm width
B2 arm width
C angle
D thickness
E bending angle
F bending angle
G angle
H1 height
H2 height
J depth
K angle
V angle
X direction
Y direction

What is claimed is:

1. A self-ligating bracket for orthodontics, comprising:
a base;
an occlusal wall extending from the base;
a gingival wall extending from the base;
a groove separating the occlusal wall and the gingival wall and extending continuously in a direction from mesial to distal;
a fastening side facing away from the groove for adhesively bonding the bracket to a lingual or vestibular surface of a tooth;
a slit extending in a direction from gingival to occlusal;
and a resilient clamp, which comprises a first clamp leg and a second clamp leg, which are connected to each other by an occlusally or gingivally arranged clamp bend, wherein the first clamp leg is inserted in the slit and can be moved therein in gingival-occlusal direction between a closed position and an open position of the clamp;
wherein the clamp has an access opening in the area of the clamp bend for engagement of a bracket opener;
wherein the access opening, in a view along the longitudinal direction of the first clamp leg or in a top view of the clamp unwound into a plane, is delimited laterally by two arms running in a V-shape towards each other;
wherein a distance (A) measured from mesial to distal between the mesial arm and the distal arm is at least as large as the arm width (B1; B2) of each of the two arms measured from mesial to distal;
wherein the cross-section of the clamp in the area of the clamp bend outside the access opening has a minimum which is referred to as the minimum cross-section;
wherein each of the arms has an arm cross-section in the area of the access opening; and
wherein the sum of the two arm cross-sections at one point of the clamp bend is not more than 10% less than the minimum cross-section.

2. The bracket according to claim 1, wherein the arm width (B1; B2) of each of the two arms is half as wide as the smallest width (B) of the clamp bend in the area outside the access opening.

3. The bracket according to claim 1, wherein the cross-section of the clamp in the area of the clamp bend has a maximum which is referred to as the maximum cross-section, and the maximum cross-section is not more than 20% larger than the minimum cross-section.

4. The bracket according to claim 1, wherein segments of the clamp bend whose cross-sections are more than 10% larger than the minimum cross-section extend over maximally 20% of the total bending angle (F) of the clamp bend over a bending angle not exceeding 30°.

5. The bracket according to claim 1, wherein the distance (A) between the two arms is at least 0.7 mm.

6. The bracket according to claim 1, wherein the angle (V) between the two arms is in the range of 40° to 75°.

7. The bracket according to claim 1, wherein the angle (V) between the two arms is in the range of 45° to 70°.

8. The bracket according to claim 1, wherein one of the arms, in a top view of the clamp unwound into a plane, extends at an angle (C; C′; C″; C″) to the longitudinal direction of the clamp in the range of 20° to 45°.

9. The bracket according to claim 1, wherein one of the arms, in a top view of the clamp unwound into a plane, extends at an angle (C; C′; C″; C″) to the longitudinal direction of the clamp in the range of 23° to 33°.

10. The bracket according to claim 1, wherein the oblong access opening extends over at least 50% of the total clamp bend.

11. The bracket according to claim 1, wherein the oblong access opening extends over at least 55% of the total clamp bend.

12. The bracket according to claim 1, wherein the oblong access opening extends over a bending angle (E) of the clamp bend of at least 100°.

13. The bracket according to claim 1, wherein the oblong access opening extends over a bending angle (E) of the clamp bend of at least 120°.

14. The bracket according to claim 1, wherein a segment of the clamp bend in which the two arms run parallel to each other adjoins the segment of the clamp bend in which the two arms run in a V-shape towards each other.

15. The bracket according to claim 1, wherein the clamp bend, as viewed in a longitudinal section through the first clamp leg, has a center which lies at a first height (H1) above the first clamp leg, wherein the end of the access opening facing the first clamp lies at a second height (H2) above the first clamp leg, and wherein the second height (H2) is in a range delimited by the first height (0.8*H1) reduced by 20% and the first height (1.2*H1) increased by 20%.

16. The bracket according to claim 1, which comprises a support surface for a bracket opener, which faces the clamp bend and runs obliquely to the first clamp leg at an angle (G) from 60° to 85°.

17. The bracket according to claim 1, wherein the wall assigned to the clamp bend, as viewed along the longitudinal direction of the first clamp leg, comprises a recess at its end facing away from the base of the groove, in which recess sits the second clamp leg and/or the clamp bend of the clamp located in its closed position.

18. The bracket according to claim 17, wherein the depth (J) of the recess is at least 80% of the thickness (D) of the clamp.

19. A series of self-ligating brackets for orthodontics, comprising a number of the brackets according to claim 1, wherein the minimum cross-section of the clamp in the area of the clamp bend of one of the brackets of the series differs by no more than 10% from the respective minimum cross-section of each of the other brackets of the series.
